(19) United States
(12) Patent Application Publication
(10) Pub. No.: US 2022/0348269 A1
(43) Pub. Date: Nov. 3, 2022

(54) Modular Support Assembly for a Vehicle Bed or Cabin

(71) Applicant: Tomas Horacio Bello Flores, Longwood, FL (US)

(72) Inventor: Tomas Horacio Bello Flores, Longwood, FL (US)

(21) Appl. No.: 17/732,121

(22) Filed: Apr. 28, 2022

Related U.S. Application Data
(60) Provisional application No. 63/182,023, filed on Apr. 30, 2021.

(51) Int. Cl. B62D 33/02

(52) U.S. Cl. CPC B62D 33/0207

(57) ABSTRACT

The present disclosure provides a modularly designed support assembly for a vehicle cargo cabin or bed which is easily adjustable in both height and width by the inclusion of telescopic support bars and multiple fitting points along the support bars. This leads to a versatile structure that easily facilitates the expansion of the cargo space, addition or removal of certain support bars for different configurations, and for the assembly itself to adjust to different sizes of vehicle cargo area.

### CROSS REFERENCES TO RELATED APPLICATIONS

The present application claims the benefit and priority of U.S. provisional application No. 63/182,023, filed Apr. 30, 2021.

### FIELD OF INVENTION

The present disclosure relates to support systems for truck beds and other vehicles. In particular, the present disclosure relates to a modular and adjustable support system, sub-assemblies, and components of the system.

### BACKGROUND

Existing truck bed racks typically utilize several vertical or substantially vertical supports on each side of the truck bed. Horizontally-extending beams (“cross bars”) extend between upper ends of at least some of the opposing pairs of vertical supports. In some cases, longitudinally-extending beams extend along the upper ends of the vertical supports. The lateral and longitudinal beams are typically placed slightly above a height of the roof of the truck cab so that items can be supported above the roof line.

The vertical location of the cross bars is often too low to accommodate taller items, such as motorcycles, in the truck bed. However, because the cross bars are structural elements of the rack, they cannot be removed without removal of the entire rack. Most truck bed racks are intended to be permanent and are not easily removed.

Furthermore, it is generally the case that specific assemblies are required to be purchased for different vehicles due to the dimensions of the cargo cabin/truck bed varying.

It is within this context that the present invention is provided.

### SUMMARY

The present disclosure provides a modularly designed support assembly for a vehicle cargo cabin or bed which is easily adjustable in both height and width by the inclusion of telescopic support bars and multiple fitting points along the support bars. This leads to a versatile structure that easily facilitates the expansion of the cargo space, addition or removal of certain support bars for different configurations, and for the assembly itself to adjust to different sizes of vehicle cargo area.

Thus, according to one aspect of the present disclosure there is provided a modular support assembly for mounting upon a cargo cabin of a vehicle, the assembly comprising: two or more first mounting elements, each configured to lock on to a first portion of a vehicle cabin rail and further configured to receive a vertical support; two or more first telescopic vertical supports, each comprising an outer base portion and an inner sliding portion, each base portion being configured to lock on to one of the first mounting elements and each sliding portion being configured to receive a horizontal support and to extend or retract with respect to the base portion and lock at a certain extension.

The assembly further comprises two or more second mounting elements, each configured to lock on to a second portion of a vehicle cabin rail and further configured to receive a vertical support; two or more second telescopic vertical supports, each comprising an outer base portion and an inner sliding portion, each base portion being configured to lock on to one of the second mounting elements and each sliding portion being configured to receive a horizontal support and to extend or retract with respect to the base portion and lock at a certain extension; and two or more horizontal support bars configured to lock onto the sliding portions of the telescopic vertical supports at multiple points along its length.

In some embodiments, the assembly further comprises two or more telescopic horizontal top support bars, each comprising an outer base portion and an inner sliding portion, each base portion being configured to lock on to a first horizontal support bar and each sliding portion being configured to lock on to a second horizontal support bar and to extend or retract with respect to the base portion and lock at a certain extension.

In some embodiments, the assembly further comprises two or more telescopic horizontal side support bars, each comprising an outer base portion and an inner sliding portion, each base portion being configured to lock on to a first vertical support bar and each sliding portion being configured to lock on to a second vertical support bar and to extend or retract with respect to the base portion and lock at a certain extension.

In some embodiments, the assembly further comprises two or more side plates, each configured to lock on to a mounting element and a vertical support bar.

Each telescopic bar may comprise one or more holes along the length of both the base portion and the length of the sliding portion, and wherein the extension of the telescopic bar is locked by aligning a hole of the base portion and a hole of the sliding portion and affixing them together with a nut and washer assembly.

### BRIEF DESCRIPTION OF THE DRAWINGS

Various embodiments of the invention are disclosed in the following detailed description and accompanying drawings.

FIG. 1 illustrates a first example configuration of the modular assembly of the present disclosure.

FIG. 2 illustrates a second example configuration of the modular assembly of the present disclosure.

FIG. 3A illustrates an isometric view of an example configuration of a mounting element of the modular assembly of the present disclosure attaching to a first kind of vehicle cargo area rail.

FIG. 3B illustrates a side-on view of an example configuration of a mounting element of the modular assembly of the present disclosure attaching to a first kind of vehicle cargo area rail.

FIG. 4A illustrates an isometric view of an example configuration of a mounting element of the modular assembly of the present disclosure attaching to a second kind of vehicle cargo area rail.

FIG. 4B illustrates a side-on view of an example configuration of a mounting element of the modular assembly of the present disclosure attaching to a second kind of vehicle cargo area rail.

FIG. 5 illustrates a stage of construction of a first support assembly part on a vehicle cargo area.

FIG. 6A illustrates a first type of joint used in constructing the first support assembly part of FIG. 5.

FIG. 6B illustrates a second type of joint used in constructing the first support assembly part of FIG. 5.

FIG. 6C illustrates a third type of joint used in constructing the first support assembly part of FIG. 5.

FIG. 7 illustrates a stage of construction of a second support assembly part on the vehicle cargo area.

FIG. 8 illustrates a stage of construction of the support assembly where the first and second parts are completed.

FIG. 9 illustrates a final stage of construction of a first configuration of the modular support assembly where telescopic longitudinal support bars are added to connect the first and second parts.

FIG. 10 illustrates a final stage of construction of an alternative configuration of the modular support assembly where only the first assembly part is used and side plates are added.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

The present disclosure relates to a modular assembly of interconnecting pieces configured to from various configurations for supporting cargo in or on the rear cargo cabin of a vehicle such as a pickup truck.

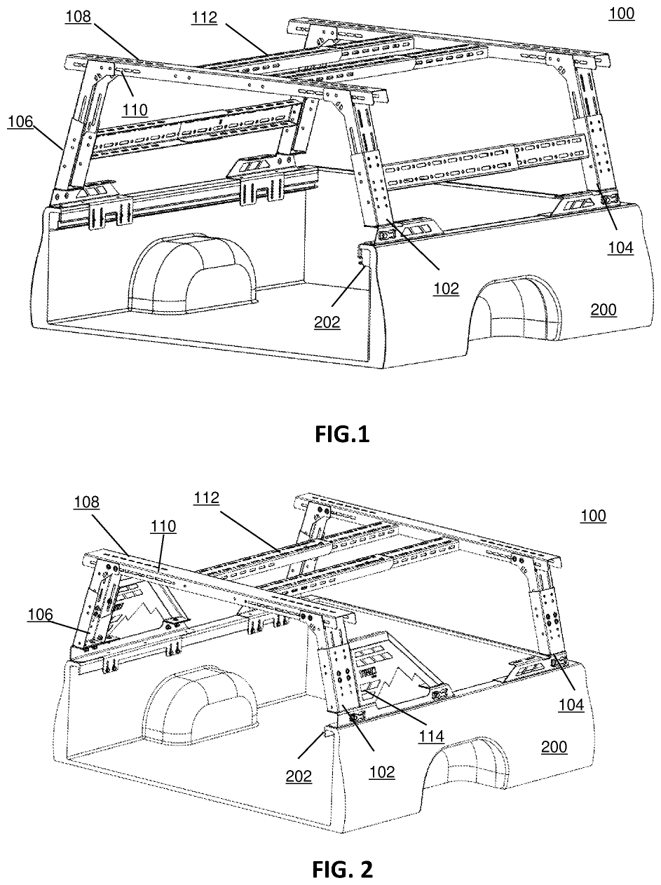

Referring to FIG. 1 and FIG. 2, first and second example configurations of the modular assembly 100 of the present disclosure are shown mounted on the rear bed of a pickup truck 200.

As shown, the assembly generally comprises first 102 and second 104 parts that are mounted atop the side rails 202 of the vehicle. The first and second parts of the assembly consist of vertical support bars 106 which are telescopic and this allow adjustment of the height of the assembly, and horizontal support bars 108 which can connect to the vertical support bars 106 at various fitting points 110 along their length—this allows the assembly 100 to be fitted to cargo areas on vehicles of different sizes.

In some configurations (see FIG. 10) only one of the first and second parts may be included. However, generally, both first 102 and second 104 parts are included with one or more telescopic longitudinal bars 112 connected therebetween to improve structural integrity.

In the configuration of FIG. 1, telescopic longitudinal bars 112 are included on both the sides and top of the assembly, whereas in the configuration of FIG. 2 the side longitudinal bars 112 are replaced with side plates 114 which are mounted on the rails 202.

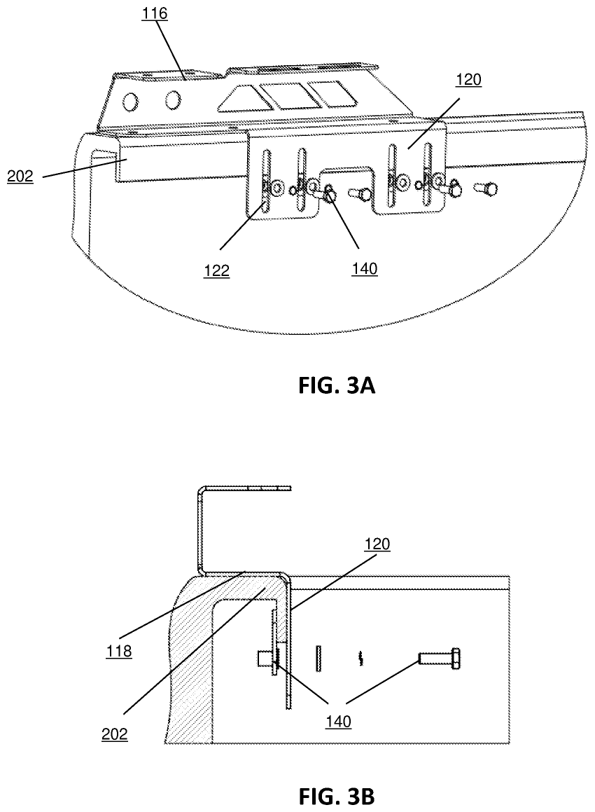

Referring to FIG. 3A and FIG. 3B, isometric and side-on views are shown of first example configuration of a mounting element 116 attaching to a first kind of vehicle cargo area rail 202. Generally, such rails either comprise one of two types. The type shown here is a hooked rail.

The mounting element 116, which forms the base of the assembly connecting it to the vehicle 200 and upon which the vertical telescopic support bars 106 are mounted, is formed of a shaped metal piece that has a flat underside 118 and an overhang 120 with a plurality of vertical openings 122 in it. A nut and washer assembly 140 affixes the mounting element 116 in place over the hooked rail 202 by inserting through an appropriate point along the vertical openings.

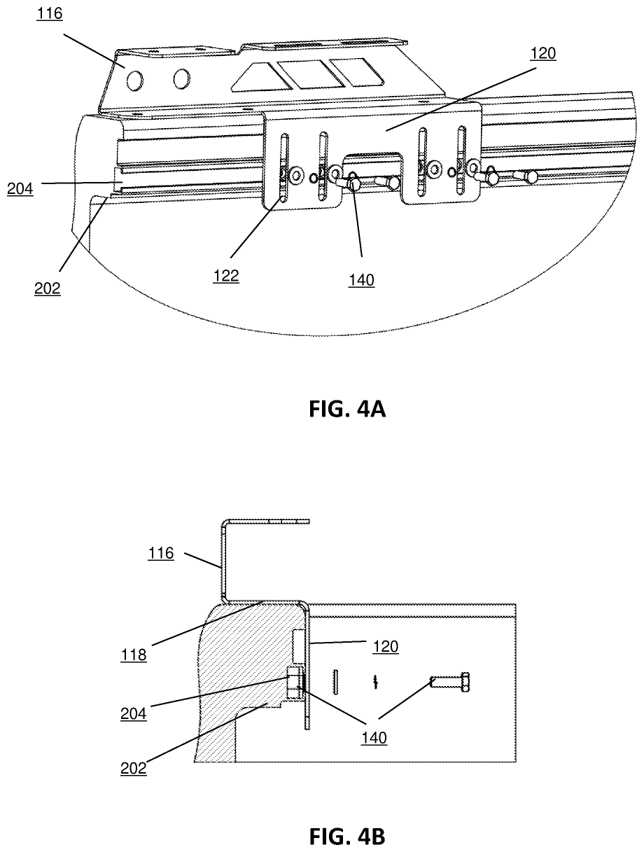

Referring to FIG. 4A and FIG. 4B, the same configuration of mounting element 116 is shown being affixed in place over the second common type of vehicle rail 202.

This type of vehicle rail has a thicker top portion which has one or more grooves 204 running along the inside of its length. The shape of the mounting element 116 is exactly the same for mounting to this type of rail, it simply connects in a different way by the nut of the nut and washer assembly being inserted into the rail groove 204.

Once the mounting elements 116 have been affixed to the vehicle rails 202, the construction of the modular assembly atop the mounting elements 116 can proceed.

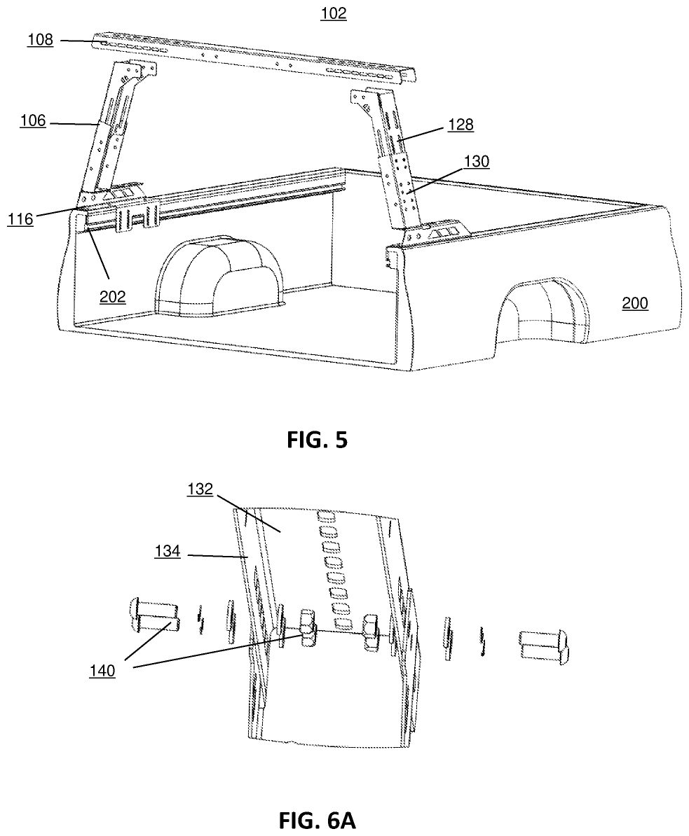

Thus, referring to FIG. 5 a stage of construction of a first support assembly part 102 on the vehicle cargo area 200 is shown.

The vertical telescopic support bars 106 are assembled—they each comprise an inner sliding portion 128 and outer base portion 130 as described below—and then each affixed on atop a respective mounting element 116. A horizontal support bar 108 having a plurality of fixing points along its length is then placed over the opposing vertical support bars 106 to from a first part 102 of the assembly.

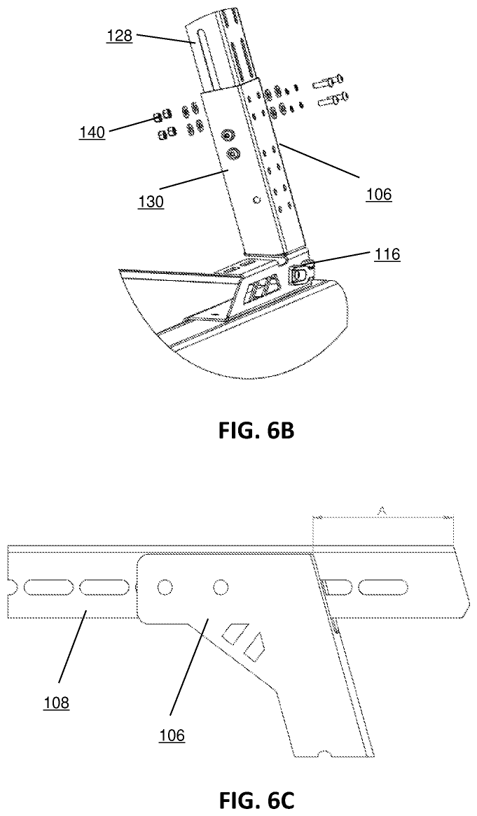

Referring to FIG. 6A, FIG. 6B, and FIG. 6C, various types of joint used in the construction of the first part 102 of the assembly are shown in more detail.

The support bars of the assembly are generally in the form of a flat metal bar 132 having a width and a length, and with an orthogonal overhang 134 running along the entire length of each edge of the bar at a 90 degree angle to form a squared off “C” shape. Various openings are disposed along both the bar 132 and the overhangs 134, and the support bars are generally formed of a durable rigid material such as an appropriate metal.

The telescopic components of the modular assembly 100 are generally formed of a first one of these bars of a first width which is an inner sliding portion 128 and a second such bar of a slightly greater width which is an outer base portion 130. The inner sliding portion 128 fits within the outer base portion 130 and can freely slide with respect to it along the axis of their parallel lengths. This effectively forms a bar that can extend or retract to a desired length. Furthermore, once a desired length has been reached, the plurality of openings in the inner portion 128 can be aligned with those of the outer portion 130 and a nut and washer assembly 140 is inserted through the openings to affix them together at that length.

FIG. 6A shows a nut and washer assembly 140 being inserted through openings in the overhangs 134 and FIG. 6B shows a nut and washer assembly 140 being inserted through openings in the bar 132.

FIG. 6C shows an example configuration for a connection between the top portion of the vertical support bars 106 and the horizontal support bar 108. This is a similar concept where openings are aligned for affixing by a nut and washer assembly.

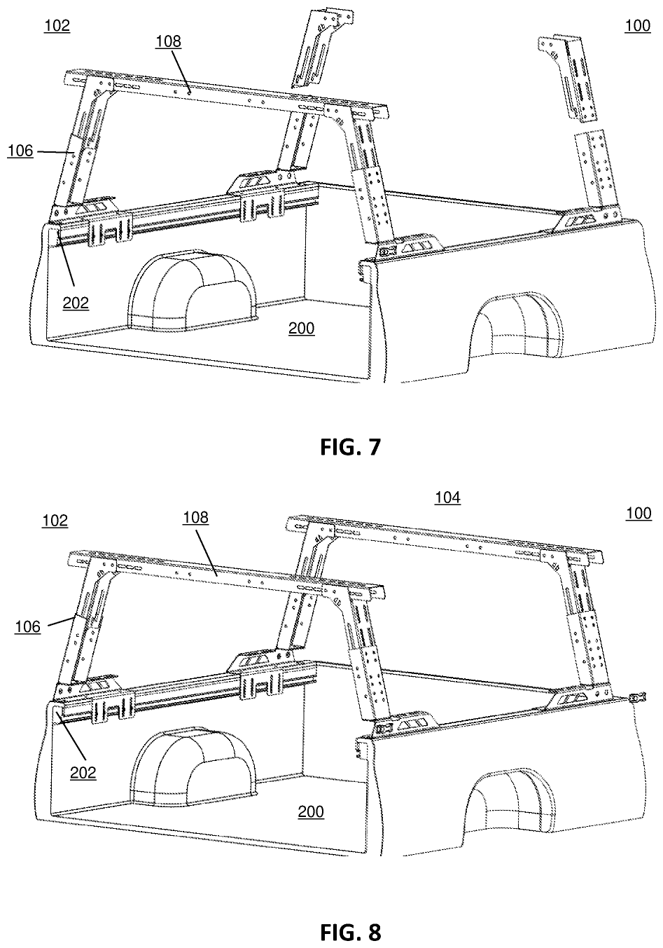

FIG. 7 and FIG. 8 show later stages of construction of the modular support assembly 100 with the second support assembly part 104 being placed over the vehicle cargo area 200.

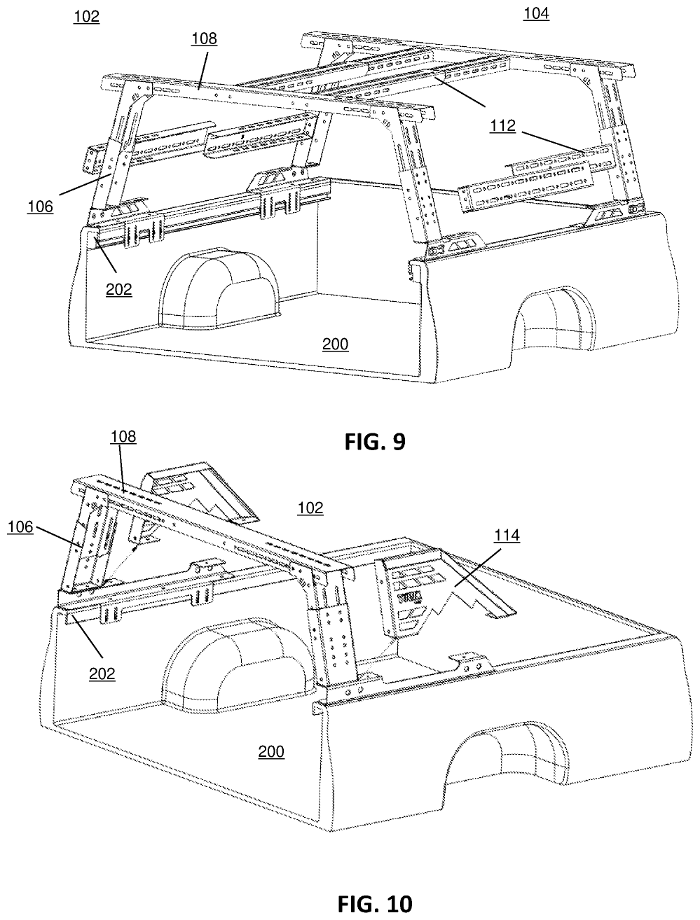

Referring to FIG. 9, a final stage of construction of a first configuration of the modular support assembly 100 is shown where telescopic longitudinal support bars 112 are added to connect the first 102 and second parts 104.

Alternatively, the final stage of construction may only comprise the first part 102 as shown in FIG. 10 where only the first assembly part 102 is used and side plates 114 are added.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the modular support assembly have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A modular support assembly for mounting upon a rear bed or cabin of a vehicle, the assembly comprising:
two or more first mounting elements, each configured to lock on to a first portion of a vehicle cabin rail and further configured to receive a vertical support;
two or more first telescopic vertical supports, each comprising an outer base portion and an inner sliding portion, each base portion being configured to lock on to one of the first mounting elements and each sliding portion being configured to receive a horizontal support and to extend or retract with respect to the base portion and lock at a certain extension;
two or more second mounting elements, each configured to lock on to a second portion of a vehicle cabin rail and further configured to receive a vertical support;
two or more second telescopic vertical supports, each comprising an outer base portion and an inner sliding portion, each base portion being configured to lock on to one of the second mounting elements and each sliding portion being configured to receive a horizontal support and to extend or retract with respect to the base portion and lock at a certain extension; and
two or more horizontal support bars configured to lock onto the sliding portions of the telescopic vertical supports at multiple points along its length.

2. A modular support assembly according to claim 1, further comprising two or more telescopic horizontal top support bars, each comprising an outer base portion and an inner sliding portion, each base portion being configured to lock on to a first horizontal support bar and each sliding portion being configured to lock on to a second horizontal support bar and to extend or retract with respect to the base portion and lock at a certain extension.

3. A modular support assembly according to claim 1, further comprising two or more telescopic horizontal side support bars, each comprising an outer base portion and an inner sliding portion, each base portion being configured to lock on to a first vertical support bar and each sliding portion being configured to lock on to a second vertical support bar and to extend or retract with respect to the base portion and lock at a certain extension.

4. A modular support assembly according to claim 1, further comprising two or more side plates, each configured to lock on to a mounting element and a vertical support bar.

5. A modular support assembly according to claim 1, wherein each telescopic bar comprises one or more holes along the length of both the base portion and the length of the sliding portion, and wherein the extension of the telescopic bar is locked by aligning a hole of the base portion and a hole of the sliding portion and affixing them together with a nut and washer assembly.
